(19) United States
(12) Patent Application Publication
(10) Pub. No.: US 2006/0109381 A1
(43) Pub. Date: May 25, 2006

(54) Display apparatus with function of receiving broadcast signal and control method thereof

(76) Inventors: Hong-Jae Kim, Suwon-si (KR); Kik-bok Moon, Seoul (KR); Jae-gong Hong, Suwon-si (KR); Young-Jin Yoon, Suwon-si (KR)

Correspondence Address: STANZIONE & KIM, LLP, 919 18TH STREET, N.W., SUITE 440, WASHINGTON, DC, 20006, US

(21) Appl. No.: 11/272,134

(22) Filed: Nov. 14, 2005

(30) Foreign Application Priority Data
Nov. 22, 2004 (KR) 2004-96007
Apr. 29, 2005 (KR) 2005-36314

(51) Int. Cl. H04N 5/50

(52) U.S. Cl. 348/569

(57) ABSTRACT

The invention relates to a display apparatus that receives a broadcast signal and includes a selection input, an on screen display (OSD) generator and a display part to display a video signal thereon, including a memory to store information about broadcast standards corresponding to regional information of the display apparatus; and a controller to control the OSD generator under predetermined conditions to display an OSD menu on the display part to select the regional information, and set the broadcast standards of the display apparatus based on the information about the broadcast standards stored in the memory when a user selects the regional information through the selection input.

### CROSS-REFERENCE TO RELATED APPLICATIONS

This application claims priority to and the benefit of Korean Patent Application No. 10-2004-0096007, filed on Nov. 22, 2004 and Korean Patent Application No. 10-2005-0036314, filed on Apr. 29, 2005, which are hereby incorporated by reference for all purposes as if fully set forth herein.

### BACKGROUND OF THE INVENTION

1. Field of the Invention

The invention relates to a display apparatus that receives a broadcast signal and a control method thereof, and more particularly, to a display apparatus that receives a broadcast signal and a control method thereof to automatically adjust a television (TV) broadcast standard.

2. Description of the Related Art

A conventional display apparatus that receives a broadcast signal has preset TV broadcast standards, e.g., the TV broadcast standards are set when the display apparatus is sold.

However, even when the TV broadcast standards are preset, a user may select a language and TV/CATV signals according to a Plug & Play method when the display apparatus is first powered.

The TV broadcast standards include the United States National Television Systems Committee (NTSC), the Phase Alternation by Line (PAL), and the Sequentiel Couleur Memoire (SECAM).

The conventional display apparatus is not appropriate for a multi broadcasting system because each country or region utilizes different TV broadcast standards and the TV broadcast standards are preset in the display apparatus according to the specification of the country where the display apparatus is manufactured. As described above, a user may only select the language and TV/CATV signals. The TV broadcast standards are set to a factory mode, which is difficult to be reset.

Conversely, a World Wide TV provides various languages and selects an appropriate TV broadcasting standard according to a geographic region or country where the World Wide TV is being used.

Users may select the TV broadcast standards of the wide world TV themselves when initially applying power thereto.

However, unless users are well aware of the TV broadcast standards, it would be difficult for them to select the appropriate TV broadcast standard for their TV.

### SUMMARY OF THE INVENTION

Accordingly, the invention to provide a display apparatus that receives a broadcast signal and a control method thereof, which automatically sets TV broadcast standards corresponding to a region selected by a user.

Additional features of the invention will be set forth in the description which follows, and in part will be apparent from the description, or may be learned by practice of the invention.

The present invention discloses a display apparatus that receives a broadcast signal, including a selection input, an on screen display (OSD) generator and a display part to display a video signal thereon; a memory storing information relating to broadcast standards corresponding to regional information; and a controller controlling the OSD generator to display an OSD menu on the display part so that the regional information may be selected, and setting the broadcast standards of the display apparatus according to the information relating to the broadcast standards stored in the memory when the regional information is selected through the selection input.

The present invention also discloses a method of setting broadcast standards for a display apparatus that receives a broadcast signal and includes a display part to display a video signal thereon, including displaying an OSD menu on the display part for selecting regional information of the display apparatus; and setting the broadcast standards of the display apparatus according to the selected regional information once the regional information is selected.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a control block diagram of a display apparatus according to an embodiment of the invention.

FIG. 2 shows pictures displayed on a display apparatus to describe a method of setting TV broadcast standards of the display apparatus according to an embodiment of the invention.

FIG. 3 is a control flow chart of the method of setting the TV broadcast standards of the display apparatus according to an embodiment of the invention.

### DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

Reference will now be made in detail to the embodiments of the present invention, examples of which are illustrated in the accompanying drawings, wherein like reference numerals refer to like elements throughout. A television (TV) will be described as one type of a display apparatus, which is able to receive a broadcast signal. However, it is understood that various types of display apparatus may be used and the invention is not limited to a TV.

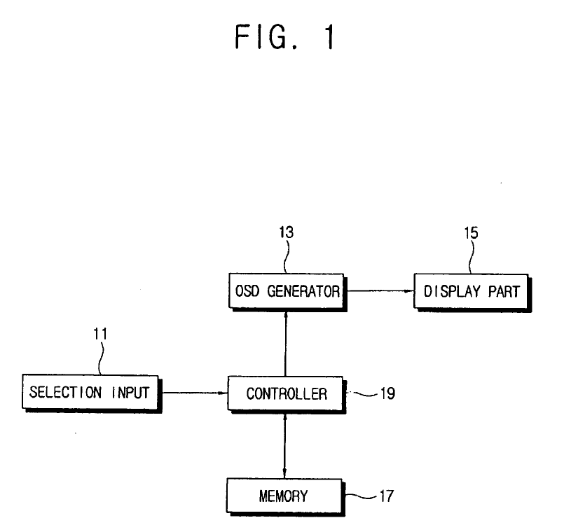

As shown in FIG. 1, a display apparatus according to an embodiment the invention includes a selection input 11, an on screen display (OSD) generator 13, a display part 15, a memory 17 and a controller 19. The display apparatus may be a television (TV).

The selection input 11 outputs a key signal to the controller 19 according to a user's adjustment. The selection input 11 may include a menu key to set regional information; an up/down/left/right adjustment key to direct and/or select respective items of a menu; and a key signal generator to generate the key signal corresponding to the key adjustment. The selection input 11 may be provided as an input device such as a mouse, a keyboard, or a wireless controller. When a user adjusts controls using the selection input 11, the key signal generator generates the key signal corresponding to the user's adjustment, which is applied to the controller 19. Accordingly, the controller 19 controls the OSD generator 13 corresponding to the key signal input from the key signal generator.

The selection input 11 is a device that enables a user to input a selection such as by a touch screen or a touch pad.

The OSD generator 13 generates an OSD menu to adjust display conditions of the display apparatus. The OSD generator 13 may be realized as IC chips. The OSD generator 13 may be included in a video signal processor (not shown) that receives and processes broadcast signals.

The OSD menu is provided so that a user may set the display apparatus according to an appropriate region. For example, the OSD menu may include a continent selection menu that includes a plurality of continent items, and a country selection menu that includes a plurality of country items corresponding to the continent items. The OSD menu may further include a language selection menu that includes a plurality of languages so that an appropriate or understandable language may be selected for the OSD menu.

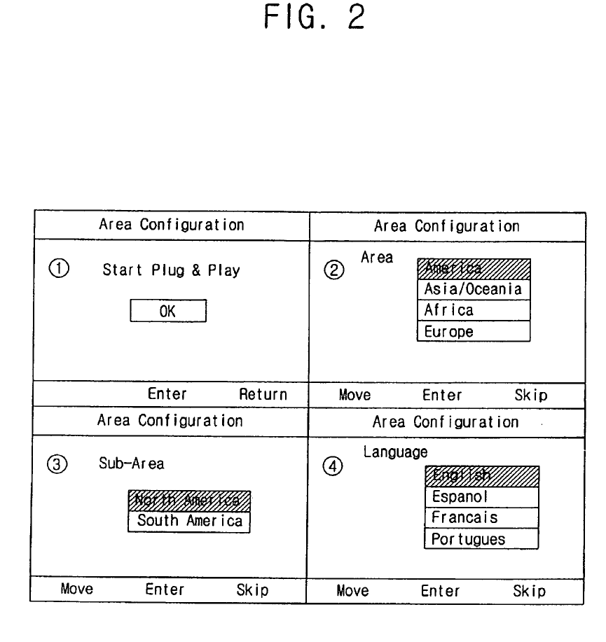

As shown in FIG. 2, the continent selection menu may include continent items such as “America”, “Asia”, “Oceania”, “Africa”, “Europe”, etc. The continent selection menu is not limited to the continents shown in FIG. 2. The country items include the countries that are in the respective continents.

The display part 15 receives a video signal from the video signal processor (not shown) and a menu signal from the OSD generator 13 to display an image. The display part 15 includes a display panel to display the picture thereon and a panel driver. The display part 15 may be a cathode ray tube (CRT), a liquid crystal display (LCD), a plasma display panel (PDP), etc.

The memory 17 stores information about various broadcast standards corresponding to continent, country, region, etc. The memory 17 may be a read only memory (ROM), an erasable programmable read only memory (EPROM), an electrically erasable programmable read only memory (EEPROM), etc. It is understood that the memory 17 may be separately provided from the display apparatus. Alternatively, the memory 17 may be provided in the controller 19 (to be described later) of the display apparatus.

When a user inputs the menu key signal to set the regional information through the selection input 11, the controller 19 controls the OSD generator 13 to generate a menu corresponding thereto and display it on the display part 15. Also, the controller 19 sets the display apparatus broadcast standards according to the information stored in the memory 17, when the regional information is selected or input through the selection input 11. A register may be used to set the display apparatus broadcast standards. The register may be provided externally or in the controller 19.

The display apparatus may operate according to the set broadcast standards. The controller 19 may be a controller for a microcomputer, etc.

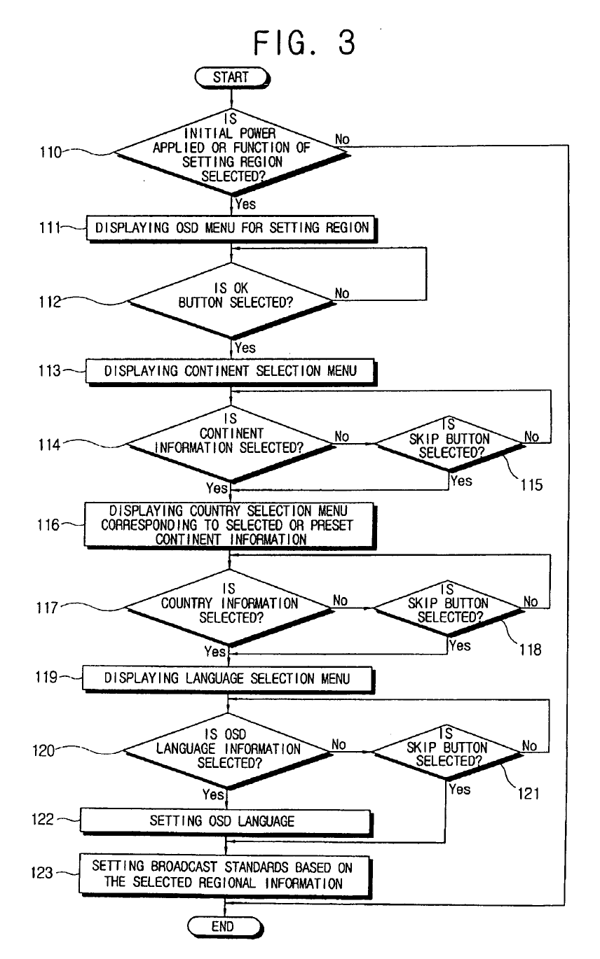

A method of setting the display apparatus broadcast standards according to an embodiment of the invention is described below with reference to FIG. 2 and FIG. 3.

As shown in FIG. 2, when power is initially applied to the display apparatus at operation 110, a region setting menu 1 is displayed on the display part 15 according to a Plug & Play method at operation 111. The region setting menu 1 is displayed by implementing a program in the controller 19 which is programmed in advance, regardless of the input signal.

When the controller 19 receives the key input signal corresponding to selection or input of the region setting menu key of the selection input 11 at operation 110, even though the initial power is not applied thereto, the controller 19 controls the OSD generator 13 to generate the region setting menu and display it to the display part 15. For example, if the display apparatus is initialized by pressing a reset button of the selection input 11, a user may reselect the region and set the broadcast standards.

The background of the OSD menu may be turned off when power is initially applied thereto. When the menu is generated according to a menu key input, a picture processed through the video signal processor combined and output with the menu.

When a user selects or inputs an OK button, e.g., a confirmation button through the adjustment of the selection input 11 at operation 112, a continent selection menu 2 is displayed on the display part 15, as shown in FIG. 2 and at operation 11 3.The conversion from the menu 1 to menu 2 may be performed automatically.

The menu 2 may be provided as the continent selection menu to select the continent information.

A user may select a desired item by making an adjustment or selection using the selection input 11. They may be various sub items of the OSD picture, such as “Move”, “Enter”, “Skip”, etc.

For example, a user may select “Move” to direct the desired item, “Enter” to select the desired item, and “Skip” to skip menus.

For example, if a user adjusts the selection input 11 to select “America” from the continent items at operation 114, the controller 19 controls the OSD generator 13 to display “Sub-Area” as a sub menu comprising “North America” and “South America” as sub items of “America”, i.e., the country selection menu to select country information corresponding to the selected continent item, at operation 116. If a user selects “Skip” at operation 115, the controller 19 controls the OSD generator 13 to generate “Sub-Area” corresponding to the continent information which is the default continent information or set in advance to display the sub-area information on the display part 15 at operation 116.

Thus, if a user adjusts the selection input 11 to select “North America” from among the continent selection menu, the display apparatus broadcast standards are determined accordingly at operation 123. The display apparatus broadcast standards may be set as one of the United States National Television Systems Committee (NTSC), the Phase Alternation by Line (PAL) and the Sequentiel Couleur Memoire (SECAM) according to the selected regional information.

The display apparatus broadcast standards setting menu according to an embodiment of the invention may include a language selection menu to select OSD language information. For example, if the country information is selected as shown in FIG. 2, the OSD menu may be displayed as a next menu to select the language at operation 119. If a user selects “Skip”, the display apparatus broadcast standards are instantly determined at operation 123. The OSD language may be displayed as the default or the preset language.

If a user selects one of, for example, “English”, “Espanol”, “Francais” or “Portugues” displayed on the OSD menu at operation 120, the OSD language is set at operation 122.

A user may then easily set the broadcast standards corresponding to the regional condition.

In the foregoing embodiment, the television is described as an example of the present invention. However, it is understood that the display apparatus is not limited to a television, for example, a display apparatus which includes television functions, for example, a multi function monitor, may be used.

Although the above described embodiments refer to a continent selection and a sub-area, e.g., country, selection, it is understood that the invention is not limited thereto. For example, the continent selection menu may be replaced with any type of information to select and the sub-area may include any type of related information.

Although a few embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A display apparatus that receives a broadcast signal, comprising:
a selection input, an on screen display (OSD) generator and a display part to display a video signal thereon;
a memory storing information relating to broadcast standards corresponding to regional information; and
a controller controlling the OSD generator to display an OSD menu on the display part so that the regional information may be selected, and setting the broadcast standards of the display apparatus according to the information relating to the broadcast standards stored in the memory when the regional information is selected through the selection input.

2. The display apparatus of claim 1, wherein the controller controls the OSD generator when power is initially input to the display apparatus.

3. The display apparatus of claim 2, wherein the OSD menu for selecting the regional information comprises a continent selection menu and a country selection menu, and wherein the broadcast standards comprise the United States National Television Systems Committee (NTSC), the Phase Alternation by Line (PAL) and the Sequentiel Couleur Memoire (SECAM).

4. The display apparatus of claim 3, wherein the OSD menu further comprises a language selection menu for selecting a language for the OSD information.

5. The display apparatus of claim 1, wherein the OSD menu comprises a continent selection menu and a country selection menu, and wherein the broadcast standards comprise the United States National Television Systems Committee (NTSC), the Phase Alternation by Line (PAL) and the Sequentiel Couleur Memoire (SECAM).

6. The display apparatus of claim 5, wherein the OSD menu further comprises a language selection menu for selecting a language for the OSD information.

7. A method of setting broadcast standards for a display apparatus that receives a broadcast signal and comprises a display part to display a video signal thereon, comprising:
displaying an OSD menu on the display part for selecting regional information of the display apparatus; and
setting the broadcast standards of the display apparatus according to the selected regional information once the regional information is selected.

8. The method of claim 7, wherein the controller controls the OSD generator when power is initially input to the display apparatus.

9. The method of claim 8, wherein displaying the OSD menu comprises displaying a continent selection menu and a corresponding country menu when the continent information is selected.

10. The method of claim 9, wherein displaying the OSD menu comprises displaying a language selection menu for selecting a language for the OSD information.

11. The method of claim 7, wherein the broadcast standards comprise the United States National Television Systems Committee (NTSC), the Phase Alternation by Line (PAL) and the Sequentiel Couleur Memoire (SECAM).
